(19) United States
(12) Patent Application Publication
(10) Pub. No.: US 2023/0233895 A1
(43) Pub. Date: Jul. 27, 2023

(54) FIRE PREVENTION SYSTEM

(71) Applicant: Francesco Carta, Hallandle Bch, FL (US)

(72) Inventor: Francesco Carta, Hallandle Bch, FL (US)

(21) Appl. No.: 18/094,076

(22) Filed: Jan. 6, 2023

Related U.S. Application Data
(60) Provisional application No. 63/303,660, filed on Jan. 27, 2022.

(51) Int. Cl. A62C 37/44; A62C 37/36

(52) U.S. Cl. CPC A62C 37/44; A62C 37/04

(57) ABSTRACT

A fire prevention system connected to a building, the fire prevention system including a plurality of sensors removably connected on at least a portion of the building to detect at least one of a fire and smoke in response to at least one of the smoke moving toward at least one of the plurality of sensors, an increase in a temperature level of air, and an increase in a temperature level of at least one surface of the building, a plurality of vapor dispensing pipes disposed on at least a portion of the building to dispense water onto at least one surface of the building in response to at least one of the plurality of sensors detecting at least one of the smoke, the increase in the temperature level of the air, and the increase in the temperature level of the at least one surface of the building, and a plurality of fire retardant dispensing pipes disposed on at least a portion of the building to dispense the fire retardant onto at least one surface of the building in response to at least one of the plurality of sensors detecting at least one of the smoke, the increase in the temperature level of the air, and the increase in the temperature level of the at least one surface of the building.

### CROSS-REFERENCE TO RELATED APPLICATIONS

This application claims priority under 35 USC § 120 from U.S. Provisional Application No. 63/303,660, entitled “Fire Prevention System,” which was filed on Jan. 27, 2022, in the United States Patent and Trademark Office, the disclosure of which is incorporated herein in its entirety by reference.

### BACKGROUND

### 1. Field

The present general inventive concept relates generally to a fire prevention, and particularly, to a fire prevention system.

### 2. Description of the Related Art

A fire in a building, such as a home can be a dangerous situation. In most cases, a smoke detector is present in the building to alert people in the event of a fire. Moreover, some people have fire extinguishers that help stop a fire.

However, even with these types of fire prevention equipment in place, numerous residences and businesses still succumb to a major fire. Unsurprisingly, it is important to stop the fire before it spreads, as fires can cause substantial property damage and/or fatal injury to any person trapped within the property while the fire remains in progress.

Therefore, there is a need for a fire prevention system that immediately stops the fire from spreading once it is detected within the building.

### SUMMARY

The present general inventive concept provides a fire prevention system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a fire prevention system connected to a building, the fire prevention system including a plurality of sensors removably connected on at least a portion of the building to detect at least one of a fire and smoke in response to at least one of the smoke moving toward at least one of the plurality of sensors, an increase in a temperature level of air, and an increase in a temperature level of at least one surface of the building, a plurality of vapor dispensing pipes disposed on at least a portion of the building to dispense water onto at least one surface of the building in response to at least one of the plurality of sensors detecting at least one of the smoke, the increase in the temperature level of the air, and the increase in the temperature level of the at least one surface of the building, and a plurality of fire retardant dispensing pipes disposed on at least a portion of the building to dispense the fire retardant onto at least one surface of the building in response to at least one of the plurality of sensors detecting at least one of the smoke, the increase in the temperature level of the air, and the increase in the temperature level of the at least one surface of the building.

Each of the plurality of sensors may include a central processing unit that compares at least one of the temperature level of the air and the temperature level of the at least one surface of the building to a predetermined temperature level that indicates the building is at least one of on fire and a fire is within a predetermined proximity of the building.

Each of the plurality of sensors may be protected by a fireproof cover.

The plurality of fire retardant dispensing pipes may cover an entirety of a roof of the building.

The fire prevention system may further include a vapor generator disposed on and within at least a portion of the building and connected to a water supply within the building to generate liquid vapor to be dispensed within the plurality of vapor dispensing pipes.

Each of the plurality of sensors may control at least one of a pump of the plurality of vapor dispensing pipes to dispense a liquid vapor and a pump of the plurality of fire retardant dispensing pipes to dispense the fire retardant at a high level of speed based on a danger level of the fire.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a perspective view of a fire prevention system as disposed on a building, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

List of Components

Fire Prevention System 100
Sensors 110
Vapor Dispensing Pipes 120
Fire Retardant Dispensing Pipes 130
Vapor Generator 140

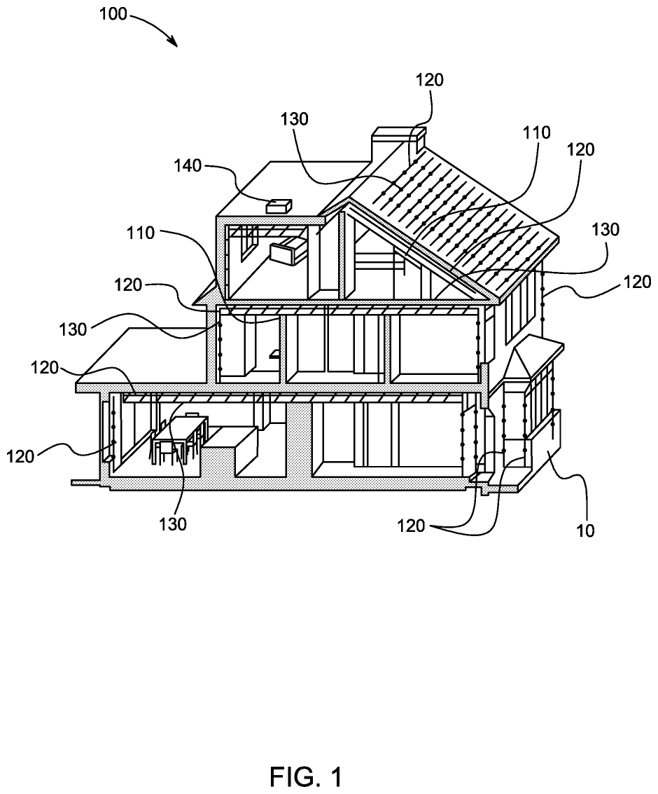

FIG. 1 illustrates a perspective view of a fire prevention system 100 as disposed on a building 10, according to an exemplary embodiment of the present general inventive concept.

The fire prevention system 100 may be constructed from at least one of metal, plastic, wood, and rubber, etc., but is not limited thereto.

The fire prevention system 100 may include a plurality of sensors 110, plurality of vapor dispensing pipes 120, a plurality of fire retardant dispensing pipes 130, and a vapor generator 140, but is not limited thereto.

Each of the plurality of sensors 110 may include a central processing unit (CPU), a pump, a microcontroller, a fire sensor, a smoke detector, and a heat sensor, but is not limited thereto.

The plurality of sensors 110 may be removably connected on and/or within at least a portion of the building 10. Each of the plurality of sensors 110 may detect a fire and/or smoke in response to smoke moving toward at least one of the plurality of sensors 110 and/or an increase in a temperature level of air and/or a surface of the building 10 based on the CPU comparing the temperature level to a predetermined temperature level that indicates the building 10 is on fire and/or a fire is within a predetermined proximity of the building 10 (e.g., two feet, five feet, ten feet, twenty feet, etc.).

Furthermore, each of the plurality of sensors 110 may be protected by a fireproof cover. In other words, the fireproof cover may surround each of the plurality of sensors 110 to prevent damage therein. As such, the fireproof cover may ensure continuous operation of each of the plurality of sensors 110 in event a fire reaches at least one of the plurality of sensors 110.

The plurality of vapor dispensing pipes 120 may be disposed on and/or within at least a portion of the building 10. For example, the plurality of vapor dispensing pipes 120 may be disposed on a roof of the building 10, on a wall of the building 10, and/or on a ceiling of the building 10. Moreover, the plurality of vapor dispensing pipes 120 may be connected to each of the plurality of sensors 110. Each of the plurality of sensors 110 may send a first signal to at least one of the plurality of vapor dispensing pipes 120 to dispense water therefrom using the pump of the plurality of vapor dispensing pipes 120 onto at least one surface (e.g., roof, wall, ceiling, corner) of the building 10 in response to detecting the smoke and/or the increase in the temperature level corresponding to a fire. However, the plurality of vapor dispensing pipes 120 may cover an entirety of the at least one surface, such as an entirety of the roof, at least one wall, and/or at least one ceiling.

As such, the plurality of vapor dispensing pipes 120 may wet and/or dampen the at least one surface to decrease likelihood of spread of the fire.

Each of the plurality of fire retardant dispensing pipes 130 may store a fire retardant therein. For example, the fire retardant may be constructed of eighty-five percent water, ten percent fertilizer, and/or five percent additional ingredients, such as colorants, anti-corrosive material, thickeners (e.g., clay, natural gum), stabilizers, and/or bactericides. Also, each of the plurality of fire retardant dispensing pipes 130 may have a pump connected thereto.

The plurality of fire retardant dispensing pipes 130 may be disposed on and/or within at least a portion of the building 10. For example, the plurality of fire retardant dispensing pipes 130 may be disposed on a roof of the building 10, on a wall of the building 10, and/or on a ceiling of the building 10. Moreover, the plurality of fire retardant dispensing pipes 130 may be connected to each of the plurality of sensors 110. Each of the plurality of sensors 110 may send a second signal to at least one of the plurality of fire retardant dispensing pipes 130 to dispense the fire retardant therefrom using the pump of each of the plurality of fire retardant dispensing pipes 130 onto at least one surface (e.g., roof, wall, ceiling, corner) of the building 10 in response to detecting the smoke and/or the increase in the temperature level corresponding to a fire. However, the plurality of fire retardant dispensing pipes 130 may cover an entirety of the at least one surface, such as an entirety of the roof, at least one wall, and/or at least one ceiling.

As such, the plurality of fire retardant dispensing pipes 130 may prevent spread of the fire to the at least one surface by reducing flammability of the at least one surface.

The vapor generator 140 may be disposed on and/or within at least a portion of the building 10 and/or connected to a water supply within the building. The vapor generator 140 may be connected to each of the plurality of vapor dispensing pipes 120. The vapor generator 140 may generate liquid vapor to be dispensed within the plurality of vapor dispensing pipes 120. In other words, the plurality of vapor dispensing pipes 120 may emit a vapor and/or a mist of liquid vapor (e.g., water vapor), such that the plurality of vapor dispensing pipes 120 may moisten and/or dampen the at least one surface, rather than soak the at least on surface.

Collectively, the plurality of vapor dispensing pipes 120 and/or the plurality of fire retardant dispensing pipes 130 may prevent spread of the fire already on, within, and/or surrounding a perimeter of the building 10. Each of the plurality of sensors 110 may direct the pump of the plurality of vapor dispensing pipes 120 to dispense the liquid vapor and/or the pump of the plurality of fire retardant dispensing pipes 130 to dispense the fire retardant at a high level of speed and/or a high level of force based on a danger level of the fire (e.g., proximity of the fire to the building 10, the temperature level of the fire on, within, and/or around the building 10, amount of smoke within the building 10, how much of the fire has spread to the building 10 such that at least one percent of the building 10 is on fire, at least five percent of the building is on fire, etc.).

Therefore, the fire prevention system 100 may save the building 10 from catching fire. Also, the fire prevention system 100 may prevent spread of the fire on and/or within the building 10.

The present general inventive concept may include a fire prevention system 100 connected to a building 10, the fire prevention system 100 including a plurality of sensors 110 removably connected on at least a portion of the building 10 to detect at least one of a fire and smoke in response to at least one of the smoke moving toward at least one of the plurality of sensors 110, an increase in a temperature level of air, and an increase in a temperature level of at least one surface of the building 10, a plurality of vapor dispensing pipes 120 disposed on at least a portion of the building 10 to dispense water onto at least one surface of the building 10 in response to at least one of the plurality of sensors 110 detecting at least one of the smoke, the increase in the temperature level of the air, and the increase in the temperature level of the at least one surface of the building 10, and a plurality of fire retardant dispensing pipes 130 disposed on at least a portion of the building 10 to dispense the fire retardant onto at least one surface of the building 10 in response to at least one of the plurality of sensors 110 detecting at least one of the smoke, the increase in the temperature level of the air, and the increase in the temperature level of the at least one surface of the building 10.

Each of the plurality of sensors 110 may include a central processing unit that compares at least one of the temperature level of the air and the temperature level of the at least one surface of the building 10 to a predetermined temperature level that indicates the building 10 is at least one of on fire and a fire is within a predetermined proximity of the building 10.

Each of the plurality of sensors 110 may be protected by a fireproof cover.

The plurality of fire retardant dispensing pipes 130 may cover an entirety of a roof of the building 10.

The fire prevention system 100 may further include a vapor generator 140 disposed on and within at least a portion of the building 10 and connected to a water supply within the building 10 to generate liquid vapor to be dispensed within the plurality of vapor dispensing pipes 120.

Each of the plurality of sensors 110 may control at least one of a pump of the plurality of vapor dispensing pipes 120 to dispense a liquid vapor and a pump of the plurality of fire retardant dispensing pipes 130 to dispense the fire retardant at a high level of speed based on a danger level of the fire.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A fire prevention system connected to a building, the fire prevention system comprising:
a plurality of sensors removably connected on at least a portion of the building to detect at least one of a fire and smoke in response to at least one of the smoke moving toward at least one of the plurality of sensors, an increase in a temperature level of air, and an increase in a temperature level of at least one surface of the building;
a plurality of vapor dispensing pipes disposed on at least a portion of the building to dispense water onto at least one surface of the building in response to at least one of the plurality of sensors detecting at least one of the smoke, the increase in the temperature level of the air, and the increase in the temperature level of the at least one surface of the building; and
a plurality of fire retardant dispensing pipes disposed on at least a portion of the building to dispense the fire retardant onto at least one surface of the building in response to at least one of the plurality of sensors detecting at least one of the smoke, the increase in the temperature level of the air, and the increase in the temperature level of the at least one surface of the building.

2. The fire prevention system of claim 1, wherein each of the plurality of sensors comprises a central processing unit that compares at least one of the temperature level of the air and the temperature level of the at least one surface of the building to a predetermined temperature level that indicates the building is at least one of on fire and a fire is within a predetermined proximity of the building.

3. The fire prevention system of claim 1, wherein each of the plurality of sensors is protected by a fireproof cover.

4. The fire prevention system of claim 1, wherein the plurality of fire retardant dispensing pipes cover an entirety of a roof of the building.

5. The fire prevention system of claim 1, further comprising:
a vapor generator disposed on and within at least a portion of the building and connected to a water supply within the building to generate liquid vapor to be dispensed within the plurality of vapor dispensing pipes.

6. The fire prevention system of claim 1, wherein each of the plurality of sensors control at least one of a pump of the plurality of vapor dispensing pipes to dispense a liquid vapor and a pump of the plurality of fire retardant dispensing pipes to dispense the fire retardant at a high level of speed based on a danger level of the fire.
